(19) United States
(12) Patent Application Publication
(10) Pub. No.: US 2006/0169074 A1
(43) Pub. Date: Aug. 3, 2006

(54) Adjustment structure to maintain horizontal of a machine

(76) Inventors: Li-Hsien Liu, Hsinchu City (TW); Hsin-Chuan Peng, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/326,223

(22) Filed: Jan. 5, 2006

(30) Foreign Application Priority Data
Jan. 18, 2005 (TW) 094200897

(51) Int. Cl. F16H 27/02

(52) U.S. Cl. 74/89.23

(57) ABSTRACT

An adjustment structure includes a bottom seat adapted to be standing on a surface of the ground, a threaded rod formed on a face of the bottom seat, an adjusting block threadingly connected to the threaded rod to be movable relative to the bottom seat and a top seat adapted to be firmly connected to a side of the machine and securely engaged with a face of the adjusting block such that the top seat is movable relative to the bottom seat. The movement of the adjusting block allows the top seat to move simultaneously so that position of the machine is adjusted.

### BACKGROUND OF THE INVENTION

1. Field of the Invention

The present invention relates to an adjustment structure, and more particularly to an adjustment structure to maintain horizontal of a machine on the ground.

2. Description of the Prior Art

Vibration is something that you can not avoid when using a machine. Therefore, how to work with the machine and still maintain the machine in a high-degree horizontal status becomes a task that all workers try to accomplish so as to provide a satisfactory work result. To solve the problem, a fixture is invented and introduced to the market. With which, the worker is able to fix the machine on the ground of a building so that vibration caused by the operation of the machine will not influence the precision required by the machine so as to provide the result. Although this kind of fixture does provide a satisfactory stationary function to the machine, the fixture does not have the function to adjust (elevate or descend) the machine once implemented.

To overcome the shortcomings, the present invention tends to provide an improved adjustment structure to mitigate the aforementioned problems.

### SUMMARY OF THE INVENTION

The primary objective of the present invention is to provide an adjustment structure to provide the machine with a firm fixture to the ground and an adjustment function to the machine to maintain the precision of the machine.

In order to accomplish the above objective, the adjustment structure of the present invention is composed of a bottom seat, a top seat and an adjusting block movably sandwiched between the bottom seat and the top seat. Because the top seat is adapted to be securely connected to a side of the machine and movable relative to the bottom seat, the movement of the adjusting block allows the position of the machine to be changed, which accomplishes the purpose of maintaining the machine in a status to best output its performance.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the adjustment structure of the present invention;

FIG. 2 is a perspective view showing the assembled adjustment structure;

FIG. 3 is a cross sectional view taken from line 3-3 of FIG. 2;

FIG. 4 is an operational view showing that the top seat is elevated due to the rotation of the adjusting block;

FIG. 5 is a perspective schematic view showing the application of the adjustment structure to fix a machine;

FIG. 6 is a cross sectional view showing the second embodiment of the adjustment structure of the present invention;

FIG. 7 is an exploded perspective view of the third embodiment of the adjustment structure of the present invention;

FIG. 8 is an operational view showing the adjustment of the adjustment structure of the present invention;

FIG. 9 is an exploded perspective view of a fourth embodiment of the adjustment structure of the present invention; and

FIG. 10 is a cross sectional view showing a fifth embodiment of the adjustment structure of the present invention.

### DETAILED DESCRIPTION OF THE PREFERRED EMBODIMENT

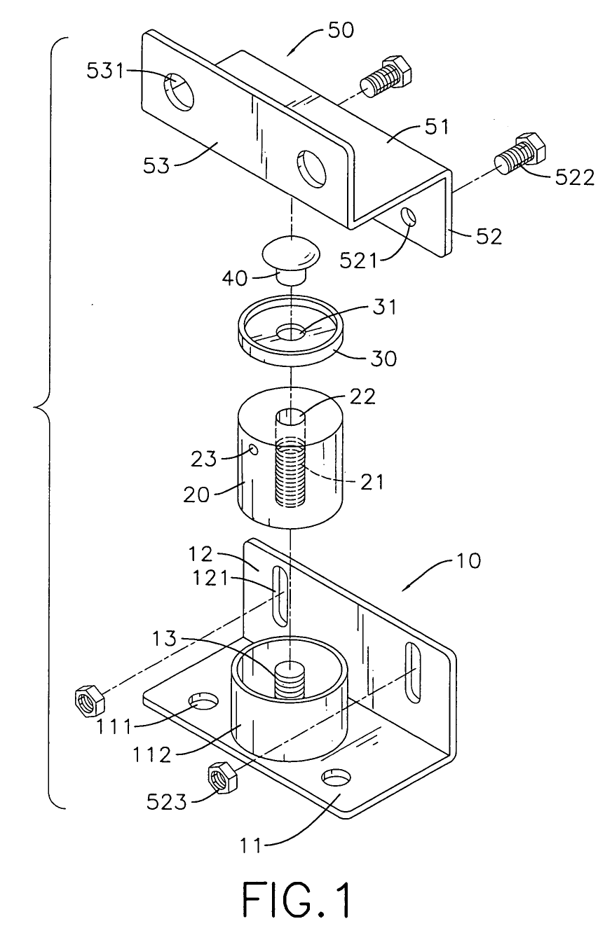

With reference to FIG. 1, it is noted that the adjustment structure in accordance with the present invention includes a bottom seat (10), an adjusting block (20), a disk (30), a push (40) and a top seat (50).

The bottom seat (10) is substantially an L shaped plate and composed of a horizontal plate (11) and a vertical plate (12) securely and integrally formed with the horizontal plate (11). The horizontal plate (11) has two first holes (111) defined therein so that bolts (not shown) can extend into the first holes (111) to mount the bottom seat (10) on the ground. A tube (112) having an opening end is mounted on a surface of the horizontal plate (11) and a threaded rod (13) is also formed on the surface of the horizontal plate (11) and inside the tube (112). The vertical plate (12) has a pair of elongated holes (121) defined therethrough.

The adjusting block (20) has a dimension slightly smaller than a diameter of the tube (112) so that the adjusting block (20) is able to be received inside the tube (112). The adjusting block (20) has a threaded passage (21) defined therein to correspond to and receive the threaded rod (13), a through hole (22) defined in a top face of the adjusting block (20) to communicate with the threaded passage (21) and an aperture (23) defined in a side face thereof.

The disk (30) has a central hole (31) in communication with the through hole (22) of the adjusting block (20). The push (40) has a T shape cross section. That is, the push (40) has a head and a body extending from a bottom of the head to extend through the central hole (31) of the disk (30) and into the through hole (22) of the adjusting block (20).

The top seat (50) has a substantially N configuration. That is, the top seat (50) is composed of a base (51), a downward skirt (52) extending from a side of the base (51) and an upward skirt (53) extending from a side of the base (51) to be opposite to the downward skirt (52). The downward skirt (52) has a pair of second holes (521) to correspond to the elongated holes (121) of the bottom seat (10) and the upward skirt (53) has a pair of third holes (531) adapted to be securely engage with a side face of a machine to be secured.

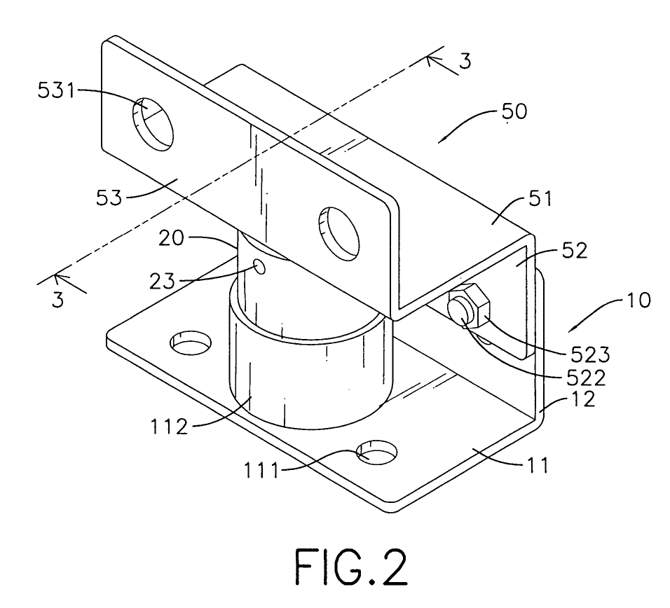

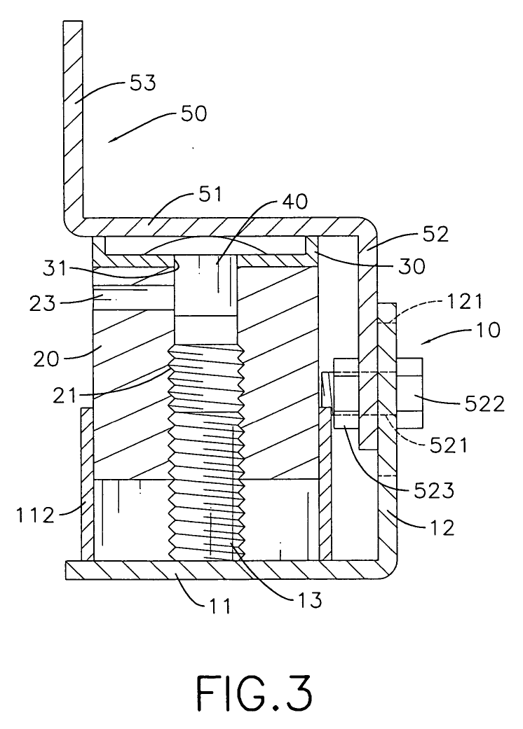

With reference to FIGS. 2 and 3, it is noted that when the adjustment structure of the present invention is assembled, the adjusting block (20) is received in the tube (112) and the threaded rod (13) is threadingly extended into the threaded passage (21) of the adjusting block (20). Then the disk (30) is placed on top of the adjusting block (20) with the central hole (31) aligned with the through hole (22) of the adjusting block (20). The body of the push (40) is extended through the central hole (31) and into the through hole (22) of the adjusting block (20) so that the disk (30) is secured on top of the adjusting block (20).

Then bolts (522) are extended through the second holes (521) and the elongated holes (121) to connect to nuts (523) so that the downward skirt (52) is securely connected to the vertical plate (12) of the bottom seat (10).

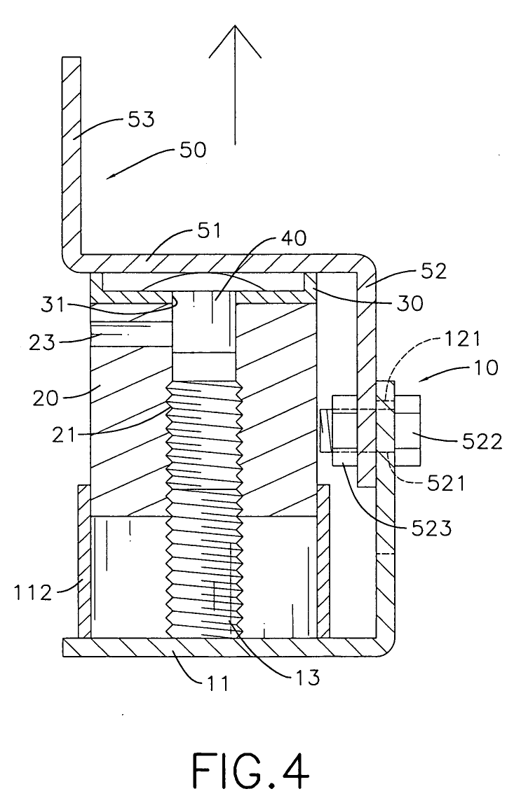

With reference to FIG. 4, rotation of the adjusting block (20) by bare hand or an auxiliary tool inserted into the aperture (23) allows the adjusting block (20), the disk (30), the push (40) as well as the top seat (50) to move relative to the bottom seat (10).

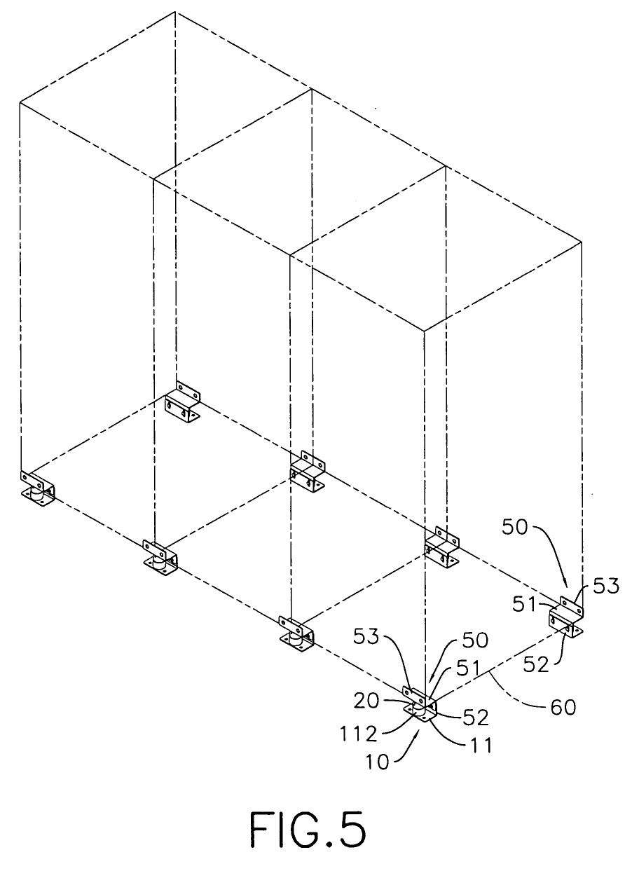

With reference to FIG. 5, it is noted that after the upward skirt (53) of the top seat (50) is securely attached to a side of a machine (60) via bolts (not shown), the user is then able to adjust the elevation of the machine (50) via the rotation of the adjusting block (20). Due to the rotation of the adjusting block (20) on the threaded rod (13), the position change of the adjusting block (20) allows the position change of the machine (60) possible. Therefore, the user is able to employ the adjustment structure of the present invention to maintain the stability as well as the horizontal of the machine (60).

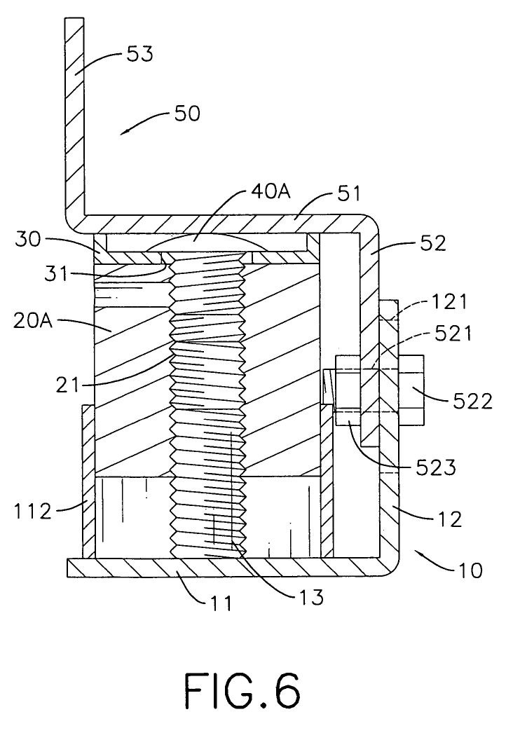

With reference to FIG. 6, a second embodiment of the present invention is shown. This embodiment includes elements almost the same as those disclosed n the first embodiment. The only difference lies in the structure of the adjusting block (20A). The adjusting block (20A) now is provided with a second threading formed on an inner periphery defining the through hole (22) so that the body of the push (40A) is able to be threadingly extended into the threaded through hole. The orientation of the second threading of the original through hole (22) is opposite to that of the threading of the threaded passage (21).

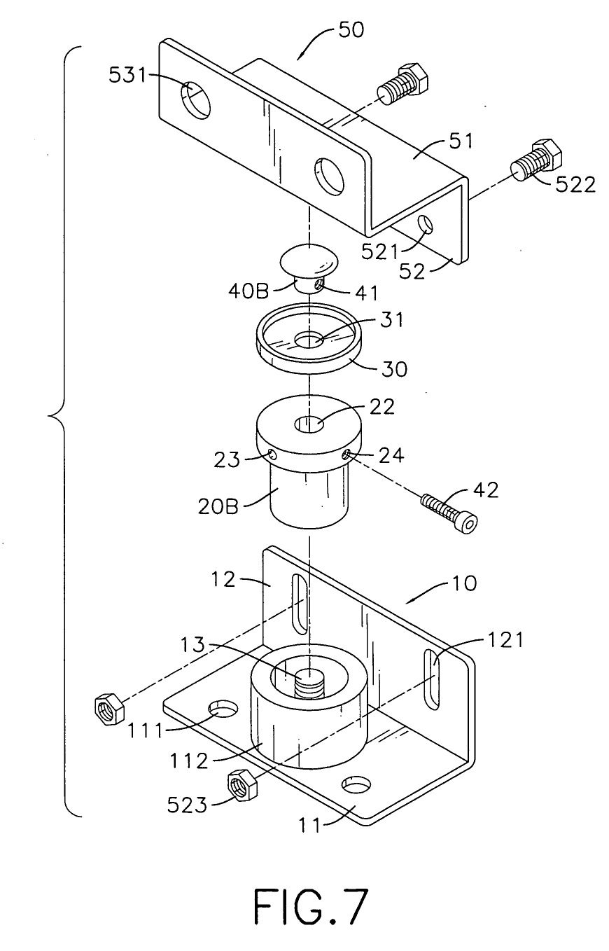

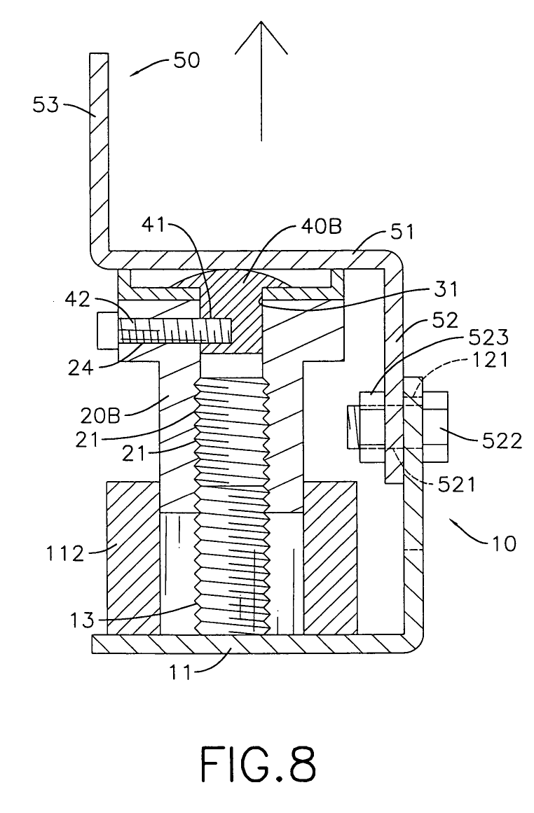

With reference to FIGS. 7 and 8, a different embodiment of the present invention is shown, wherein the adjusting block (20B) and the push (40B) respectively have structures different from those disclosed in the first embodiment. The adjusting block (20B) is further provided with a first threaded hole (24) in combination with the through hole (22). The push (40B) has a second threaded hole (41). Therefore, after the body of the push (40B) is extended into the through hole (22) of the adjusting block (20B) and the first threaded hole (24) is aligned with the second threaded hole (41), a combination bolt (42) is extended into the aligned first threaded hole (24) and the second threaded hole (41) to combine the adjusting block (20B) and the push (40B). Then after the combination between the adjusting block (20B) and the push (40), the rotation of the adjusting block (20B) also drives the push (40B) to rotate simultaneously, which still fulfills the purpose of the present invention.

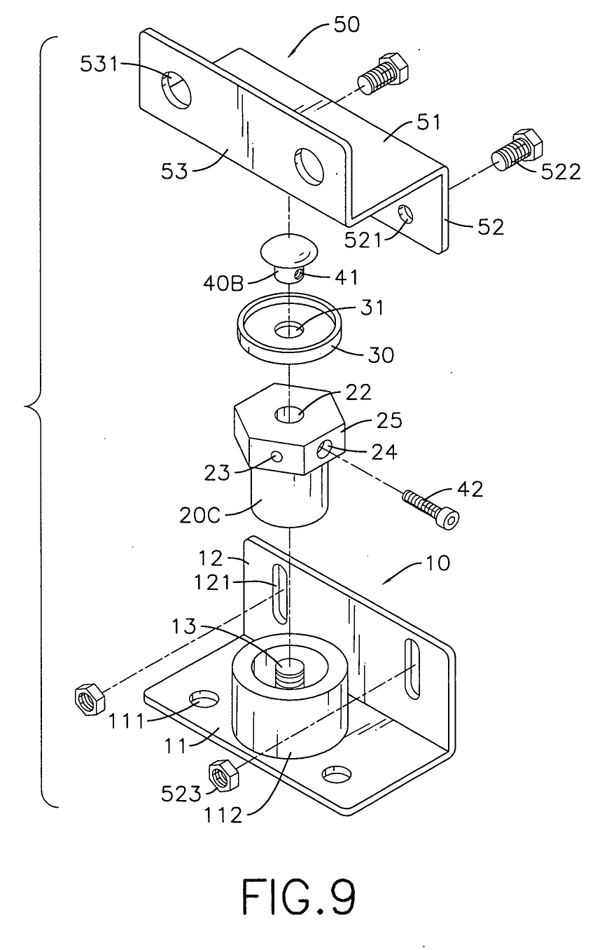

With reference to FIG. 9, the structure of the adjusting block (20C) is now changed to have a hexagonal head (25) and the first threaded hole (24) is defined in a side face of the hexagonal head (25).

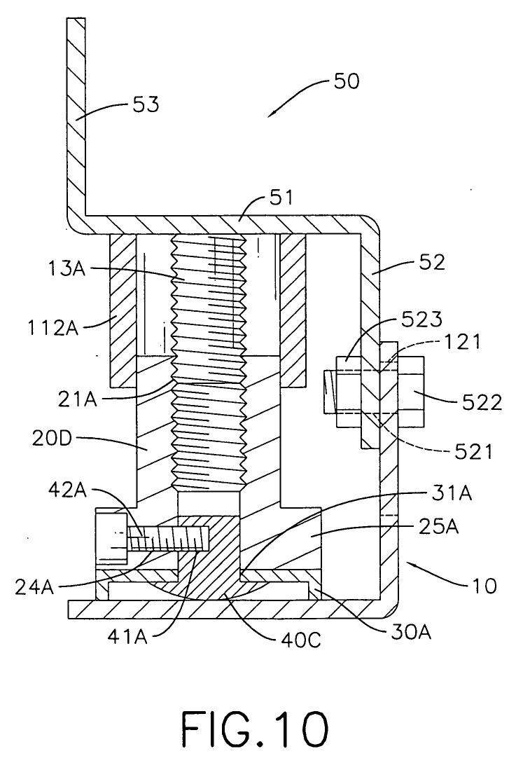

With reference to FIG. 10, a still different embodiment of the present invention is shown, wherein the disk (30A) is formed on the horizontal plate (11) of the bottom seat (10) with the head of the push (40C) received inside the disk (30A) and the body of the push (40C) extended out of the central hole (31A) of the disk (30A). The combination bolt (42A) is extended into the aligned first threaded hole (24A) and the second threaded hole (41A) to combine the adjusting block (20D) and the push (40C). Furthermore, the tube (112A) is extended from a bottom face of the base (51) of the top seat (50) and the threaded rod (13A) is extended from the bottom face of the base (51) and out of the tube (112A) to threadingly extend into the threaded passage (21A) of the adjusting block (20D). Then rotation of the adjusting block (20D) may also provide the desired result.

From the above description, it is noted that the present invention aims at providing stability of the machine in operation. Also, the adjustment structure of the present invention is able to provide adjustment function to the machine so that the machine is able to always maintain horizontal as required.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustment structure for a machine in operation so as to maintain the machine in a horizontal state, the adjustment structure comprising:
a bottom seat adapted to be standing on a surface of the ground;
a threaded rod formed on a face of the bottom seat;
an adjusting block threadingly connected to the threaded rod to be movable relative to the bottom seat; and
a top seat adapted to be firmly connected to a side of the machine and securely engaged with a face of the adjusting block such that the top seat is movable relative to the bottom seat,
whereby the movement of the adjusting block allows the top seat to move simultaneously so that position of the machine is adjusted.

2. The adjustment structure as claimed in claim 1, wherein the adjusting block has a threaded passage defined to correspond to and receive therein the threaded rod so that rotation of the adjusting block moves the top seat.

3. The adjustment structure as claimed in claim 2 further comprising a push provided with a head and a body and a disk having a central hole defined through the disk, wherein the body of the push is extended through the central hole of the disk and into a through hole defined in the adjusting block to communicate with the threaded passage such that the disk is positioned between the push and the adjusting block.

4. The adjustment structure as claimed in claim 3, wherein the bottom seat is composed of a horizontal plate and a vertical plate integrally formed with the horizontal plate and provided with a pair of elongated holes defined through a side face of the vertical plate, the top seat is composed of a base, a downward skirt extending from a side of the base and having a pair of first holes defined to respectively align with one of the elongated holes of the bottom seat to allow bolts to extend through the aligned first holes and the elongated holes to connect to nuts such that after the movement of the adjusting block, position of the top seat relative to the bottom seat is secured by securing the nuts to the bolts.

5. The adjustment structure as claimed in claim 3, a first threading is formed on an inner periphery defining the through hole of the adjusting block and a second threading is formed on an outer periphery of the body of the push so that the body of the push is able to threadingly connect to the disk.

6. The adjustment structure as claimed in claim 4, a first threading is formed on an inner periphery defining the through hole of the adjusting block and a second threading is formed on an outer periphery of the body of the push so that the body of the push is able to threadingly connect to the disk.

7. The adjustment structure as claimed in claim 1, the adjusting block has an aperture defined in a side face of the adjusting block for extension of an auxiliary tool to help rotation of the adjusting block relative to the threaded rod.

8. The adjustment structure as claimed in claim 4, the adjusting block has an aperture defined in a side face of the adjusting block for extension of an auxiliary tool to help rotation of the adjusting block relative to the threaded rod.

9. The adjustment structure as claimed in claim 7, wherein the adjusting block further has a threaded hole defined to communicate with the threaded passage, the body of the push further has a second threaded hole to align with the threaded hole of the adjusting block such that a combination bolt is able to extend into the aligned threaded hole of the adjusting block and the second threaded hole to combine the adjusting block with the push.

10. The adjustment structure as claimed in claim 8, wherein the adjusting block further has a threaded hole defined to communicate with the threaded passage, the body of the push further has a second threaded hole to align with the threaded hole of the adjusting block such that a combination bolt is able to extend into the aligned threaded hole of the adjusting block and the second threaded hole to combine the adjusting block with the push.

11. An adjustment structure for a machine in operation so as to maintain the machine in a horizontal state, the adjustment structure comprising:
a top seat adapted to be firmly connected to a side of the machine;
a bottom seat adapted to be standing on a surface of the ground;
a threaded rod extended from a bottom face of the top seat; and
an adjusting block threadingly connected to the threaded rod to be movable relative to the top seat;
whereby the movement of the adjusting block along the threaded rod allows the top seat to move simultaneously so that position of the machine is adjusted.

12. The adjustment structure as claimed in claim 11, wherein the adjusting block has a threaded passage defined to correspond to and receive therein the threaded rod so that rotation of the adjusting block moves the top seat.

13. The adjustment structure as claimed in claim 12 further comprising a push provided with a head and a body and a disk having a central hole defined through the disk, wherein the body of the push is extended through the central hole of the disk and into a through hole defined in the adjusting block to communicate with the threaded passage such that the disk is positioned between the push and the adjusting block.

14. The adjustment structure as claimed in claim 13, wherein the bottom seat is composed of a horizontal plate and a vertical plate integrally formed with the horizontal plate and provided with a pair of elongated holes defined through a side face of the vertical plate, the top seat is composed of a base, a downward skirt extending from a side of the base and having a pair of first holes defined to respectively align with one of the elongated holes of the bottom seat to allow bolts to extend through the aligned first holes and the elongated holes to connect to nuts such that after the movement of the adjusting block, position of the top seat relative to the bottom seat is secured by securing the nuts to the bolts.

15. The adjustment structure as claimed in claim 13, a first threading is formed on an inner periphery defining the through hole of the adjusting block and a second threading is formed on an outer periphery of the body of the push so that the body of the push is able to threadingly connect to the disk.

16. The adjustment structure as claimed in claim 11, the adjusting block has an aperture defined in a side face of the adjusting block for extension of an auxiliary tool to help rotation of the adjusting block relative to the threaded rod.

17. The adjustment structure as claimed in claim 14, the adjusting block has an aperture defined in a side face of the adjusting block for extension of an auxiliary tool to help rotation of the adjusting block relative to the threaded rod.

18. The adjustment structure as claimed in claim 17, wherein the adjusting block further has a threaded hole defined to communicate with the threaded passage, the body of the push further has a second threaded hole to align with the threaded hole of the adjusting block such that a combination bolt is able to extend into the aligned threaded hole of the adjusting block and the second threaded hole to combine the adjusting block with the push.
